(19) United States
(12) Patent Application Publication
(10) Pub. No.: US 2024/0107271 A1
(43) Pub. Date: Mar. 28, 2024

(54) SYSTEMS AND METHODS FOR ASSET TRACKING

(71) Applicant: Hilti Aktiengesellschaft, Schaan (LI)

(72) Inventors: Muhammad Salman MALIK, Augsburg (DE); Mihai CALIN, Zürich (CH); Roman LAMPERT, Göfis (AT); Georg HOCHMUTH, Marktoberdorf (DE)

(21) Appl. No.: 18/267,562

(22) PCT Filed: Nov. 18, 2021
(86) PCT No.: PCT/EP2021/082164

§ 371 Date: Jun. 15, 2023

Related U.S. Application Data
(60) Provisional application No. 63/126,775, filed on Dec. 17, 2020.

(51) Int. Cl. H04W 4/029; G01S 5/02

(52) U.S. Cl. CPC H04W 4/029; G01S 5/0231

(57) ABSTRACT

A system includes a first asset coupled to a first wireless tag. The first wireless tag is configured to wirelessly transmit radio wave signals at pre-determined intervals. The system also includes a first gateway configured to cover the range of a first physical location. The first gateway is configured to receive the radio wave signals from one or more wireless tags, where each wireless tag of the one or more wireless tags is coupled to an asset. The system also includes a remote asset management platform configured to receive information from one or more gateways about a plurality of wireless tags. The information includes an event indicating the status of the first asset associated with the first wireless tag. The remote asset management platform also tracks the physical location of the first asset based on the information received from one or more gateways about the plurality of wireless tags.

### BACKGROUND

The present disclosure relates generally to the field of power tools, and more particularly to systems and methods to remotely track and inventory assets.

Various assets, such as corded and cordless power tools, may be useful on a typical construction jobsite. These assets may include tools such as drill machines, saws, hammers, grinders and sanders, vacuum cleaners, drivers, measuring tools, and/or other types of tools and tool accessories. Often, assets are moved between locations (e.g., a construction jobsite, a warehouse, a container, etc.) by different groups of people. Accordingly, it may be difficult to track the location and/or the status of a particular asset within a fleet of tools owned by a particular entity. Further, it may be difficult to track a particular asset in real-time over a period of time. Assets are typically valuable resources, and it is beneficial to track the status of a particular asset in order to improve the overall efficiency of the jobsite. Furthermore, each asset may gather and store valuable data related to the construction process, and it may be beneficial to track an asset so that valuable information is not lost.

Accordingly, it is beneficial to provide for systems and methods for remotely tracking and keeping an inventory of assets owned by a particular entity. Further, it is beneficial to provide for systems and methods that track the status of a particular asset in real-time, such that assets are tracked when moved between locations, removed from a location, and/or returned to a location.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a system includes a first asset coupled to a first wireless tag. The first wireless tag is configured to wirelessly transmit radio wave signals at pre-determined intervals. The system also includes a first gateway configured to cover the range of a first physical location. The first gateway is configured to receive the radio wave signals from one or more wireless tags, where each wireless tag of the one or more wireless tags is removably coupled to an asset. The system also includes a remote asset management platform configured to receive information from one or more gateways about a plurality of wireless tags. The information includes an event indicating the status of the first asset associated with the first wireless tag. The remote asset management platform also tracks the physical location of the first asset based on the information received from one or more gateways about the plurality of wireless tags.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of an embodiment of a tool system having a plurality of assets and gateways, where the assets and gateways are assigned to logical locations and are tracked and monitored by a remote asset management platform;

FIG. 2 is a schematic of an embodiment of the tool system 100 of FIG. 1 having a plurality of assets 102, where the gateways 116 are assigned and/or preassigned to a worker 150 or a vehicle 152;

FIG. 3 is a schematic of an embodiment of the tool system of FIG. 1, where the remote asset management platform provides real-time tracking and monitoring information about the plurality of assets; and

FIG. 4 is a method of an embodiment of the tool system of FIG. 1, where the method includes alerting when an asset is removed from a predefined range of a location.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

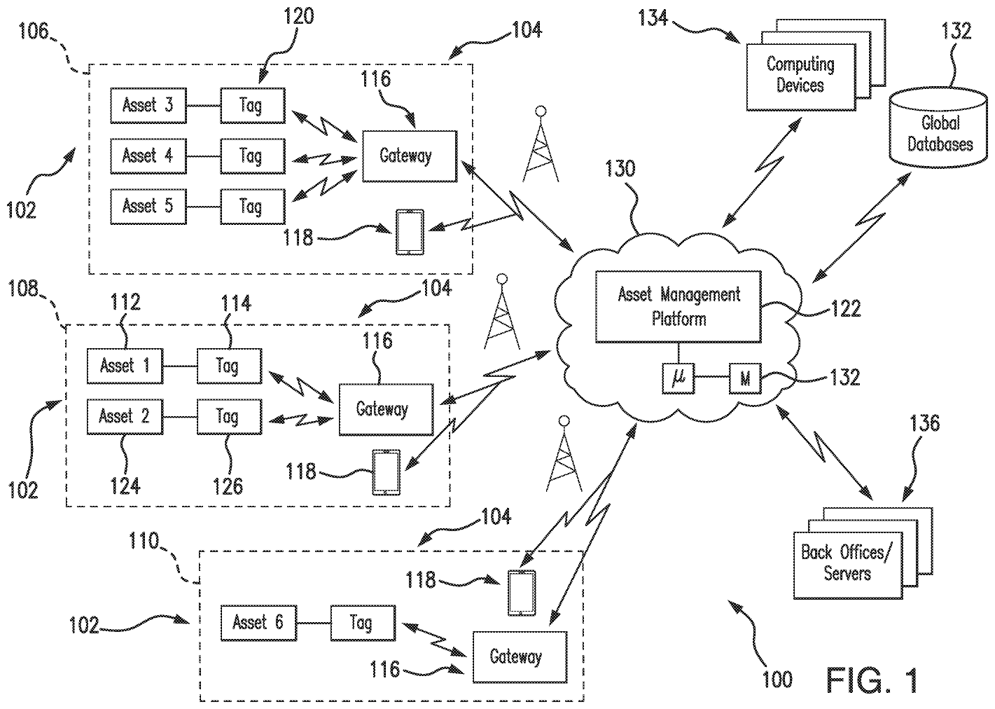

Turning now to the drawings, FIG. 1 is a tool system having a plurality of assets 102 disposed in a plurality of physical locations 104, where each of the plurality of assets is tracked with a remote asset management platform 106. The plurality of assets 102 may be owned by a particular entity (e.g., a corporation, an individual, an organization, etc.) or by several entities. For example, assets may include tools such as power tools (e.g., rotary hammers, drives, screw drivers, saws, grinders, etc.), drill machines, vacuum cleaners and accessories, measuring tools (e.g., detection tools, lasers, layout tools, surveying equipment, etc.), direct fastening tools, diamond cutting and drilling tools, tool accessories (e.g., tool boxes, kits, computing devices, etc.), and/or other types of tools and tool accessories that may be utilized within the construction industry. While the construction industry is utilized as an exemplary embodiment, it should be noted that the present embodiments may be applicable in other industries. In certain embodiments, assets may include any product, resource, or accessory utilized in an industrial setting that may be a valuable resource owned by the entity. For example, the present embodiments may be utilized to track assets in the manufacturing, energy, agriculture, transportation and logistics, or services industries. Assets in such industries may include, for example, shipping equipment, machinery, vehicles, telecommunications equipment, hardware, or any resource that may be a valuable asset for an entity.

In certain embodiments, when an entity initially purchases or acquires an asset (such as a first asset 112), the asset may be removably attached to a wireless tag (such as a first wireless tag 114). Wireless tags 120 may be active or passive tags that are configured to wirelessly transmit and receive information to/from a computing device (e.g., a gateway 116 and/or a computing device 118). The first wireless tag 114 may be registered and assigned to the first asset 112, and the association between the tag and asset may be stored within a remote asset management platform 122. In certain embodiments, the registration and assigning process may be processed by the manufacturer and/or by the entity who acquires the asset. In certain embodiments, the entity may purchase or acquire an asset already attached, registered, and assigned to the wireless tag. The process of registering a tag with a particular asset may be done with any application and computing device that can identify tags and assets. In certain embodiments, tags may be removed and replaced, so that a damaged tag may be replaced, reused on a different asset, or discarded. Additionally, tags may be re-registered with a different asset, and the new association between the tag and the new asset may be stored within the remote asset management platform 122.

In certain embodiments, the tags 120 may be removably attached to an external surface of the assets 102, or they may be attached to an accessory associated with the assets 102, such as a tool case or container. In certain embodiments, the tags 120 may be mechanically attached to the assets 102 via any attachment means (e.g., adhesive, tape, snap-on, magnet features, screws, nails, press-fit feature, etc.). In certain embodiments, the tags 120 may be disposed within a cavity located on an external surface of the assets 102. In certain embodiments, the tags 120 may be disposed within a housing of the asset 102. In particular, the wireless tags 120 may be enabled to transmit and receive information to/from the gateway 116 via one or more different wireless modes of operation, such as, but not limited to, any form of radio waves, Bluetooth, Near Field Communication (NFC), Wifi, ZigBee, LoRa, LoRaWAN, Sigfox, any wireless transmission utilizing radio waves, etc. In certain embodiments, the first wireless tag 114 may communicate in a first mode of wireless communication (e.g., NFC) while a second wireless tag 126 may communicate in a second mode of wireless communication (e.g., BLE). In certain embodiments, the tags 120 may utilize a single mode of wireless communication (e.g., BLE), and may be configured to continuously transmit beacon signals at pre-determined intervals of time (e.g., 5 seconds, 10 seconds, 15 seconds, 20 seconds, 1 minute, 5 minutes, 10 minutes, 20 minutes, 1 hour, 2 hours, 3 hours, 5 hours, 1 day, 2 days, or any interval that may be suitable to preserve battery life without compromising asset tracking).

In certain embodiments, each gateway 116 and/or the assets 102 may be assigned or preassigned to a logical location within the remote asset management platform 122. For example, each logical location within the asset management platform 122 may be a user-defined ID corresponding to the physical location 104, such as a construction jobsite 106, a warehouse 108, a container 110 (e.g., a shipping container, vehicle, mode of transportation, etc.), a worker, a transportation vehicle, etc. In particular, a logical location may differ from an actual or a geographical location having tangible geocoordinates. For example, a logical location stored within the asset management platform 122 may be a user-defined description of a physical location that assets owned by the entity are brought to, removed from, or stored within. Accordingly, the logical location may be a utility for the entity desiring to keep track of their assets' physical location within their enterprise. A logical location may be a virtual representation of an actual, physical location 104, and may be represented by the wireless range provided by the gateway 116. In certain embodiments, one or more gateways 116 (or computing devices 118) may be assigned to cover a particular physical location 104. In certain embodiments a logical location can also be hierarchical (e.g., multiple storage assets or containers within another storage asset). In certain embodiments, the gateway 116 or computing device 118 may be assigned to a fixed geolocation or a moving/dynamic area (e.g., vehicle, shipping container, etc.). Further, in certain embodiments, the gateway 116 or computing device 118 may be assigned or preassigned to a logical location, such as “vehicle X” or “container B,” which may remain constant despite the changing geolocation. Accordingly, in certain embodiments, the gateway 116 may be associated with a physical location 104 and a logical location within the remote asset management platform 122. Assets 102 brought within or removed from the proximity of the gateway 116 are monitored and recorded, and this information is stored within the asset management platform 122, as further described in detail below.

In certain embodiments, each physical location 104 may include the gateway 116 and/or the computing device 118 (e.g., smartphone, tablet, laptop, computer, etc.). In certain embodiments, the computing device 118 may be associated or owned by a worker who is proximate to the physical location 104. The gateways 116 and/or the computing device 118 may be configured to receive one or more beacon signals transmitted by one or more assets 102 within the physical location 104, or within a predetermined geographic distance from the gateway 116. The gateway 116 may be configured to receive and process the beacon signals, and transmit the information to the remote asset management platform 122, which is a cloud-based computing device 130 via WiFi (e.g., Institute of Electrical and Electronics Engineers [IEEE] 802.11X, cellular conduits (e.g., high speed packet access [HSPA], HSPA+, long term evolution [LTE], WiMax), near field communications (NFC), Bluetooth, personal area networks (PANs), and the like. In this manner, the gateway 116 may include router capabilities that allow for it to gather, analyze and transmit information to the remote asset management platform 122. The cloud-based computing device 130 may be a service provider providing cloud analytics, cloud-based collaboration and workflow systems, distributed computing systems, expert systems and/or knowledge-based systems. In certain embodiments, the cloud-based computing device 130 may be a data repository that is coupled to an internal or external global database 132.

Further, in certain embodiments, the global database 132 may allow computing devices 134 to retrieve information stored within for additional processing or analysis. Indeed, the cloud-based computing device may be accessed by a plurality of systems (computing devices 134 and/or computing devices from back offices/servers 136) from any geographic location, including geographic locations remote from the physical locations of the systems. Accordingly, the cloud 130 may enable advanced collaboration methods between parties in multiple geographic areas, provide multi-party workflows, data gathering, and data analysis, which may increase the efficiency of remotely tracking and keeping an inventory of assets owned by a particular entity in real-time.

In particular, assets 102 brought within or removed from the proximity of the gateways 116 are monitored and recorded, and this information is stored within the asset management platform 122. For example, when the first asset 112 is physically brought into the warehouse 108, the gateway 116 assigned to the warehouse 108 receives a beacon signal from the first asset 112 for the first time. In certain embodiments, the gateway 116 acknowledges the beacon signal with an acknowledgment signal. In certain embodiments, the gateway 116 records the arrival of the first asset 112 as an “event,” and transmits this information to the remote asset management platform 122. In certain embodiments, the event may include a time-stamp, operating parameters of the first asset 112, status information, unique identification information of the asset and/or battery, state of health (SOH) or state of charge (SOC) of the battery, or any other information that may be relevant to the asset or the status of the asset. The asset management platform 122 may be configured to record the event associated with the first asset 112 and maintain a historical record of events for the first asset 112. As a further example, when the first asset 112 is physically removed from the warehouse 108, the gateway 116 assigned to the warehouse 108 recognizes the missing asset by recognizing that it has not received a beacon signal from the first asset 112 for a period of time. The gateway 116 records the removal of the first asset 112 from the warehouse 108 as another “event.” As a further example, when the gateway 116 continues to receive beacon signals from the first asset 112, the gateway records “events” indicating that the first asset 112 is continuously present within its range, and therefore, within the warehouse 108.

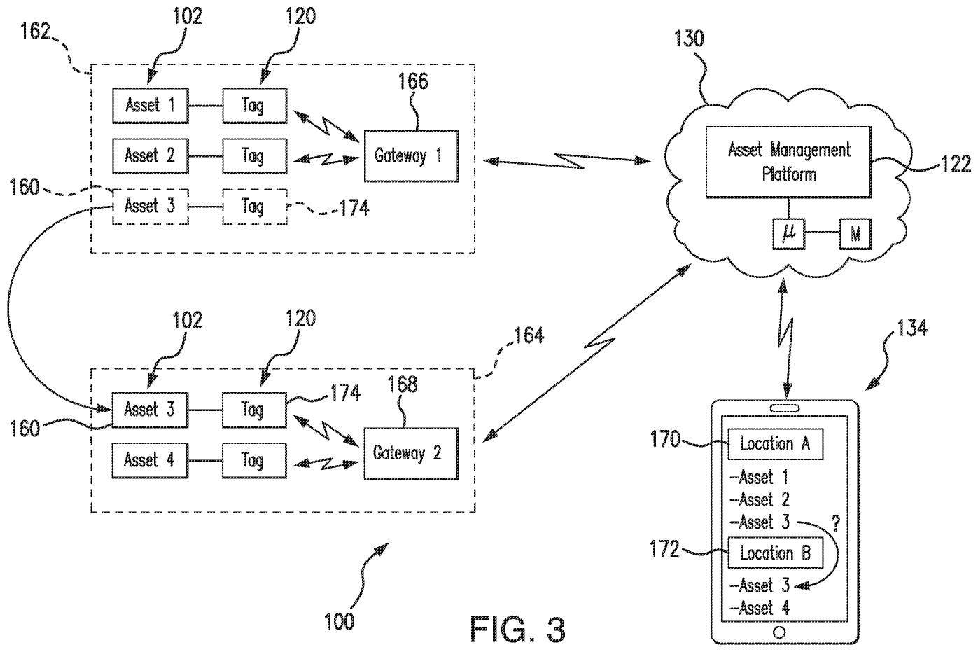

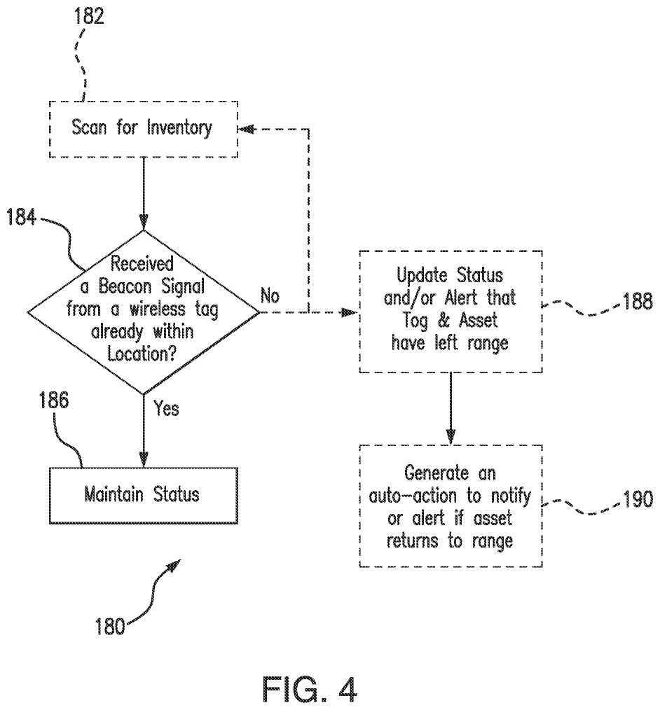

Accordingly, the asset management platform 122 records and analyzes information received from one or more gateways 116 (and/or computing devices 118), to provide real-time information about the physical location of a particular asset. In certain embodiments, the asset management platform 122 may be configured to determine whether the assets 102 are present or missing (not found) at different locations. For example, based on events recorded from two gateways 116, the asset management platform 122 may be configured to match the location of an asset 102 or group of assets 102 with the location of gateways to identify when an asset or group of assets are not found at their expected locations but are found at unexpected locations and/or brought back to their original expected locations. Based on this information, the asset management platform 122 may be configured to suggest assigning this asset or group of assets to the new location where they are seen lately and/or generate additional events or information that captures this analysis, as further described with respect to FIG. 3. As a further example, if an asset is not scanned by any gateway 116 for a period of time, the asset management platform 122 may be configured to generate an alert indicating that the asset has not been identified recently, as further described with respect to FIG. 4. The asset management platform 122 may also be configured to generate an alert or notification if this asset is registered by a gateway again. In this manner, the asset management platform 122 may be configured to remotely track and keep an inventory of assets owned by a particular entity (or multiple, independent entities) over a plurality of different locations. In particular, the entity is capable of personalizing the tracking by defining “logical locations” within the asset management platform 122 that describe a physical location 104 associated with a particular gateway 116 or computing device 118. In certain embodiments, the entity may be configured to personalize tracking by creating hierarchical logical locations that group more than one logical locations together (e.g., an asset within an asset container, one or more storage assets within a larger storage asset, etc.).

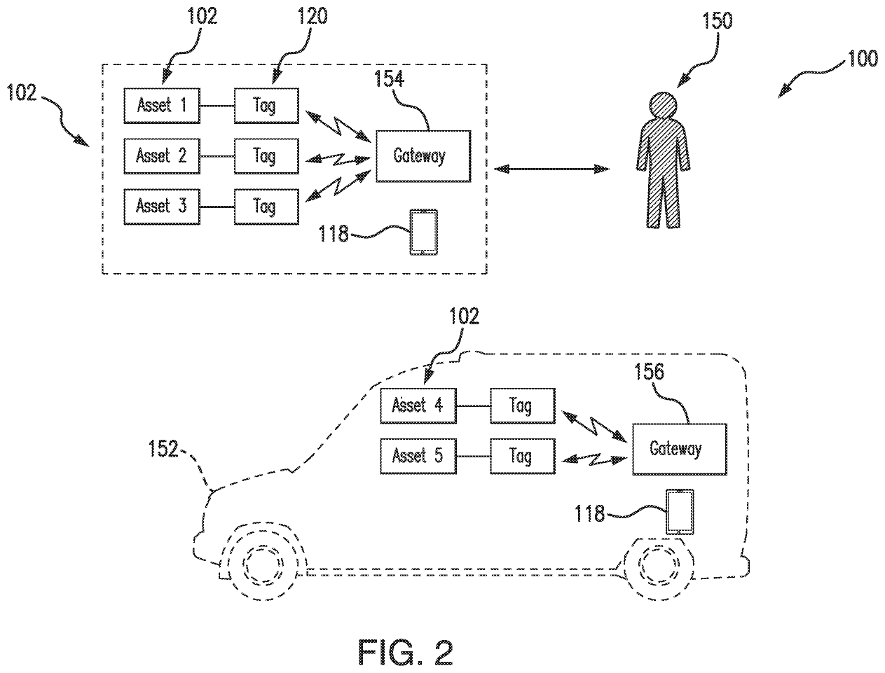

FIG. 2 is a schematic of an embodiment of the tool system 100 of FIG. 1 having a plurality of assets 102, where the gateways 116 are assigned and/or preassigned to a worker 150 or a vehicle 152. As noted above, each gateway 116 may be assigned or preassigned to a logical location within the remote asset management platform 122. Each logical location within the asset management platform 122 may be a user-defined ID corresponding to the physical location 104. In certain embodiments, the physical location 104 where the gateway 116 is disposed may be associated with a particular worker 150 or a particular mobile vehicle 152.

For example, in certain embodiments, a first gateway 154 may be associated with a particular individual, such a jobsite manager or a worker. In certain embodiments, the gateway 154 may be the worker's smartphone or other form of computing device 118. As noted above, assets 102 brought within or removed from the proximity of the first gateway 154 are monitored and recorded, and this information is stored within the asset management platform 122 as “events.” Accordingly, when the asset 102 is physically brought within the range of the worker 150, the first gateway 154 or the computing device 118 receives a beacon signal from the first asset 112. For example, in certain embodiments, the first gateway 154 records the arrival of the asset 102 as an “event,” and transmits this information to the remote asset management platform 122. In particular, the gateway 154 and the remote asset management platform 122 record the event as the asset 102 being brought within the proximity of the worker 150. For purposes of tracking the asset 102, the asset management platform 122 will identify the asset 102 as present at the location of the worker 150.

As a further example, in certain embodiments, a second gateway 156 may be associated with a vehicle 152. The vehicle may be stationary at times or dynamically moving from geolocation to geolocation. In certain embodiments, the gateway 156 may be fixed or mounted inside the vehicle 152, and may include cellular capabilities independent of the vehicle's cellular or GPS capabilities. In certain embodiments, the gateway 156 may utilize the cellular capabilities of the vehicle. Accordingly, when the asset 102 is removed from the vehicle 152 and/or loaded onto the vehicle 152, the gateway 156 identifies these activities as “events,” and transmits this information to the asset management platform 122. As a further example, when the second gateway 156 continues to receive beacon signals from the asset 102, the gateway records “events” indicating that the asset 102 is continuously present within its range, and therefore, within the vehicle 152.

FIG. 3 is a schematic of an embodiment of the tool system 100 of FIG. 1, where the remote asset management platform 122 tracks an asset 160 that is removed from a first location 162 and added to a second location 164. For example, in certain embodiments, the first location 162 may be a physical warehouse where assets are stored until they are removed for use on a second location 164, which may be a jobsite. As depicted in the illustration, the asset 160 is moved from within the range of a gateway 166 and moved closer to the range of a gateway 168. In certain embodiments, the gateway 166 may be associated with the physical location 162 and the gateway 168 may be associated with the physical location 164. Further, in certain embodiments, the asset 160 may be associated with the physical location 162. Furthermore, in certain embodiments, a user may define a first logical location 170 for the physical location 162 (e.g., warehouse) as “Location A” within the asset management platform 122. The user may define a second logical location 172 for the physical location 164 (e.g., jobsite) as “Location B” within the asset management platform 122. In certain embodiments, the user may define the first logical location 170 for the asset 160. In other words, both assets 102 and gateways 116 may be assigned or preassigned and associated with logical locations within the asset management platform 122. The user may utilize any descriptive words or phrases unique to the entity or business to create logical locations within the asset management platform 122.

In the illustrated embodiment, the wireless tag 174 associated with the asset 160 may be configured to continuously transmit beacon signals at pre-determined intervals of time. The gateway 166 may be configured to receive the transmitted beacon signals and records the information as an “event.” In certain embodiments, the gateway 166 records the arrival of the asset 160 to the first location 162 as an “event,” and transmits this information to the remote asset management platform 122. In certain embodiments, the gateway 166 continues to receive beacon signals from the asset 160, and the gateway 166 records “events” indicating that the asset 160 is continuously present within its range, and therefore, within the warehouse 162. In certain embodiments, the gateway 166 may not receive a beacon signal from the asset 160 for a certain period of time, and may record an “event” indicating that the asset 160 is not longer within its range, and therefore, not within the warehouse 162. Likewise, the gateway 168 may record the arrival of the asset 160 as an “event,” and transmits this information to the remote asset management platform 122. In should be noted that if an asset 102 is detected by a gateway 116 at a logical location that is not what is assigned or preassigned and associated with the asset 102, the asset management platform 122 identifies that the asset 102 is located at an unexpected location within the platform 122.

In certain embodiments, the cloud-based computing device 130 may be accessed by a plurality of systems (computing devices 134 and/or computing devices from back offices/servers 136) from any geographic location, including geographic locations remote from the physical locations of the systems. In certain embodiments, a user may utilize a computing device 134 (e.g., smartphone, tablet, office computer, inventory check computing device, etc.) to check on the status of one or more assets 102. In particular, it may be beneficial to have real-time information of the status of the assets 102 (or groups of assets 102) across a plurality of locations 104. For example, when the asset 160 is identified by the gateway 168 as being within the range, the asset management platform 122 identifies the asset 160 as being located at an unexpected location. In certain embodiments, if the asset 160 was preassigned to the logical location 170, the asset management platform 122 may suggest the transfer of the asset 160 from logical location 170 (e.g., “Location A”) to logical location 172 (e.g., “Location B”). In certain embodiments, if the gateway 168 is preassigned to “Location B” and the asset 160 is found proximate to the gateway 168, the asset management platform 122 may suggest the transfer of the asset 160 from logical location 170 (e.g., “Location A”) to logical location 172 (e.g., “Location B”). In this manner, the asset management platform 122 is configured to maintain a real-time record of the assets 102 in order to track and monitor their status and location. Further, a user remote from the asset management platform 122 may have access to real-time status updates of the physical location of the assets 102.

FIG. 4 is a method 180 of an embodiment of the tool system 100 of FIG. 1, where the method 180 includes alerting when an asset 102 is not seen by any gateway 116 for a certain time period. In certain embodiments, the method includes one or more gateways 116 scanning for inventory within one or more physical locations 104 (block 182). For example, in certain embodiments, the gateways 116 may be configured to scan the region and/or request a beacon signal in between the pre-determined beacon signal intervals. In certain embodiments, the gateways 116 may not scan for inventory, but may wait to receive the beacon signals at pre-determined intervals. The method 180 further includes determining, via the gateways 116, whether the received beacon signal is from a wireless tag associated with an asset that has previously arrived to the location 104 (block 184). In other words, in certain embodiments, the method 180 is configured to determine whether an asset that was registered as being within the location 104 is still within the same location 104. If the gateway continues to receive beacon signals from the asset, the gateway records “events” indicating that the asset is continuously present within its range, and the status of the asset in asset management system is maintained at its logical location (block 186).

In certain embodiments, if the gateway 116 fails to receive a beacon signal from an asset previously indicated as within the range of the gateway 116, the method 180 includes updating the status and/or generating an alert within the asset management platform 122 (and any associated devices) that the tag and the associated asset have left the range of the gateway 116 (block 188). If the asset is not seen any gateways assigned to the logical location, it is marked as left. Further, the method 180 includes generating an auto-action to notify the user and/or alerting the user if the asset returns to the range of any gateway 116.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a first asset coupled to a first wireless tag, wherein the first wireless tag is configured to wirelessly transmit radio wave signals at pre-determined intervals;
a first gateway configured to cover a range of a first physical location, and wherein the first gateway is configured to receive a radio wave signals from one or more wireless tags, wherein each wireless tag of the one or more wireless tags is coupled to an asset; and
a remote asset management platform configured to:
receive information from one or more gateways about a plurality of wireless tags, and wherein the information comprises an event indicating a status of the first asset associated with the first wireless tag; and
track a physical location of the first asset based on the information received from one or more gateways about the plurality of wireless tags.

2. The system of claim 1, wherein the radio wave signals comprise beacon signals.

3. The system of claim 1, wherein the first gateway is configured to determine whether the first asset is within the range of the first physical location based on the radio wave signals received at the first gateway.

4. The system of claim 3, wherein the first gateway is configured to generate the event indicating that the first asset is within the range of the first physical location.

5. The system of claim 1, wherein the first gateway is configured to generate the event indicating that the first asset is not within the range of the first physical location.

6. The system of claim 1, wherein the first gateway is configured to generate a second event after a predetermined period of time to update the status of the first asset.

7. The system of claim 1, comprising a second gateway configured to cover a range of a second physical location, and wherein the second gateway is configured to determine whether the first asset is within the range of the second physical location based on the radio wave signals received at the second gateway.

8. The system of claim 7, wherein the second gateway is configured to generate the event indicating that the first asset is within the range of the second physical location.

9. The system of claim 1, wherein the remote asset management platform is configured to assign a logical location to the first asset, and wherein the logical location is a user-defined description of the physical description of where the first asset is expected to be located.

10. The system of claim 9, wherein the logical location is a hierarchical location of one or more logical locations that are grouped together.

11. The system of claim 9, wherein the remote asset management platform is configured to determine whether the received logical location of the first asset is the same as the assigned logical location.

12. The system of claim 11, wherein the remote asset management platform is configured to update the status and the assigned logical location if the received logical location of the first asset is different than the assigned logical location.

13. The system of claim 1, wherein the remote asset management platform is configured to assign a second logical location for the first gateway, wherein the second logical location is a user-defined description corresponding to the first physical location.

14. The system of claim 13, wherein the second logical location is a hierarchical location of one or more logical locations that are grouped together.

15. The system of claim 1, wherein the first physical location is a construction jobsite, a warehouse, a storage asset, a shipping container, a vehicle, a mode of transportation, a worker, a transportation vehicle, a container, or a combination thereof.

16. The system of claim 1, wherein the first gateway comprises cellular capabilities to route information to the remote asset management platform.

17. The system of claim 1, wherein the first wireless tag is removably coupled to an external surface of the first asset.
